(19) United States
(12) Patent Application Publication
(10) Pub. No.: US 2006/0138750 A1
(43) Pub. Date: Jun. 29, 2006

(54) Mounting structure of curtain airbag

(76) Inventor: Sung-Yong Park, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/304,919

(22) Filed: Dec. 14, 2005

(30) Foreign Application Priority Data
Dec. 23, 2004 (KR) 10-2004-0111433

(51) Int. Cl. B60R 21/16

(52) U.S. Cl. 280/728.2

(57) ABSTRACT

Covers are provided with a detachable portion for being separated from each other during the deployment of a cushion, thus facilitating the deployment of the cushion. A guide made of a flexible material encloses the outer periphery of the covers in which one end of the guide is fixed to an outer surface of a cover outer portion facing the exterior in relation to the detachable portion, and the other end of the guide is detachably attached to the outer surface of a cover inner portion facing the vehicle inside in relation to the detachable portion for deploying into the passenger compartment with the cushion during the expansion of the cushion and shrouding an upper end of a center pillar trim. This configuration prevents the deformation of the center pillar trim or collision of the cushion with the center pillar trim during the deployment of the curtain airbag.

### CROSS-REFERENCE TO RELATED APPLICATIONS

The present application is based on, and claims priority from, Korean Application Serial Number 10-2004-0111433, filed on Dec. 23, 2004, the disclosure of which is hereby incorporated by reference herein in its entirety.

### FIELD OF THE INVENTION

The present invention relates to a mounting structure of a curtain airbag adapted to prevent deformation of a center pillar trim or a collision of the cushion with the upper end of the center pillar trim during the expansion of the cushion, thereby improving the deploying function of the cushion.

### BACKGROUND OF THE INVENTION

Generally, the curtain airbag is installed in a head lining along the roof side rail for protecting the passenger's head against impact upon a side collision.

The disposition of the curtain airbag is in close proximity to an upper end of the center pillar trim so that the cushion of the airbag should be prevented from being collided with the center pillar trim during the deployment of the cushion for a smooth and accurate operation of the cushion.

### SUMMARY OF THE INVENTION

Embodiments of the present invention help a smooth deployment of the cushion, which inflates by gas generated from an inflator, without a collision with an upper end of a center pillar trim.

A mounting structure of a curtain airbag, in which a cushion is folded and stored in covers having detachable portions for being decoupled from each other during the expansion of the cushion to thereby facilitate the deployment of the cushion, includes a guide that is made of a flexible material for enclosing the outer periphery of the covers. One end of the guide is fixed to a predetermined outer surface of the cover whereby the guide shrouds an upper end of a center pillar trim during the deployment of the cushion.

The guide may be mounted to enclose the cushion folded in the covers and may preferably be made of a flexible material for being deployed into the passenger compartment with the cushion during the deployment of the cushion and shrouding the upper end of the center pillar trim.

The guide is fixed at one end thereof to the cover by means of sewing, adhesives, or fixing members. The cross-section of the guide may be in the shape of L, C, or O (with a cutting portion) for shrouding the cover or cushion.

### DESCRIPTION OF THE DRAWINGS

For a better understanding of the nature and objects of the present invention, reference should be made to the following detailed description with the accompanying drawings, in which:

FIGS. 1 and 2 are cross-sectional views illustrating a mounting structure of a curtain airbag in a vehicle according to a first embodiment of the present invention wherein FIG. 1 illustrates a state before the expansion of the curtain airbag, and FIG. 2 illustrates a state after the expansion of the curtain airbag;

FIGS. 3 and 4 are cross-sectional views illustrating a mounting structure of a curtain airbag in a vehicle according to a second embodiment of the present invention wherein FIG. 3 illustrates a state before the expansion of the curtain airbag, and FIG. 4 illustrates a state after the expansion of the curtain airbag;

FIG. 5 is a cross-sectional view illustrating a mounting structure of a curtain airbag in a vehicle according to a third embodiment of the present invention;

FIG. 6 is a cross-sectional view illustrating a mounting structure of a curtain airbag in a vehicle according to a fourth embodiment of the present invention; and

FIG. 7 is a cross-sectional view illustrating a mounting structure of a curtain airbag in a vehicle according to a fifth embodiment of the present invention.

### DETAILED DESCRIPTION OF THE PREFERRED EMBODIMENTS

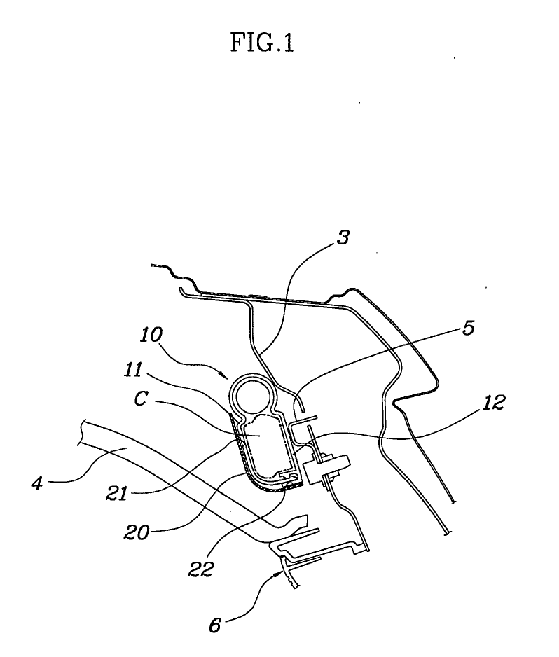

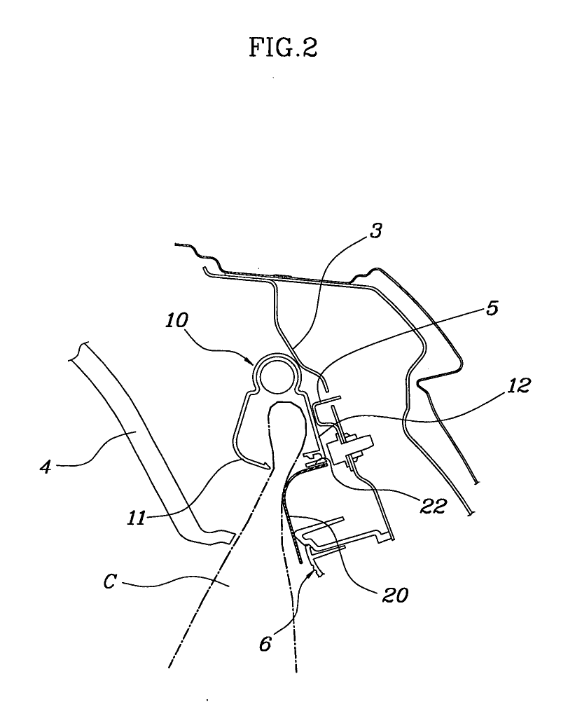

With reference to FIGS. 1 and 2, a first embodiment of the present invention includes a curtain airbag 10 that is installed between a head lining 4 and roof side inner panel 3 in a longitudinal direction of a vehicle body. A cushion (C) constituting the curtain airbag is folded (not shown) and stored in covers 11 and 12. The covers are detachably coupled at the lower ends thereof for being separated during the expansion of the cushion, thereby facilitating the deployment of the cushion. Hereinafter, a lateral side of the cover toward the exterior in relation to the above detachable portion is called a cover outer portion 12, and the other side of the cover toward the interior of the vehicle is called a cover inner portion 11.

In order to improve the deploying function of the cushion (C) placed above a center pillar trim 6, a guide 20 made of a flexible material (e.g., a textile or leather) wraps around the outer periphery of covers 11 and 12. One end of guide 20 attaches to the bottom of cover outer portion 12 to form a first contact portion 22, and the other end of guide 20 is separably attached to cover inner portion 11 and forms a second contact portion 21 for deploying toward the passenger compartment with the cushion during the expansion of the cushion and shrouding an upper end of center pillar trim 6.

First contact portion 22 should tightly be fastened for preventing one end of the guide from being detached from the cover during the expansion of the cushion (C) while second contact portion 21 should be separated from the cover in the event of the deployment of the cushion (C). Therefore, the attaching degree of the second contact portion will be enough only if it can prevent the other end of the guide from being separated from the cover when no inflation occurs in the cushion.

Guide 20 is fixed to the lower surface of cover outer portion 12 by means of sewing, adhesives, or fixing members such as a rivet. Reference numeral 5 is a bracket fixed to the inner panel.

When a vehicle collision occurs and the gas is provided from an inflator (not shown), the detachable portions of covers 11 and 12 are distanced from each other by the expansion force of the cushion (C) and the cushion inflates from the cover (see FIG. 2). Then, the cushion pushes head lining 4 and deploys into the passenger compartment. The other end of guide 20 deploys with the cushion by the expansion force of the cushion (C) and then shrouds the upper end of center pillar trim 6. This prevents the collision of the cushion (C) with the upper end of center pillar trim 6 such that the cushion can effectively deploy from the above of center pillar trim 6.

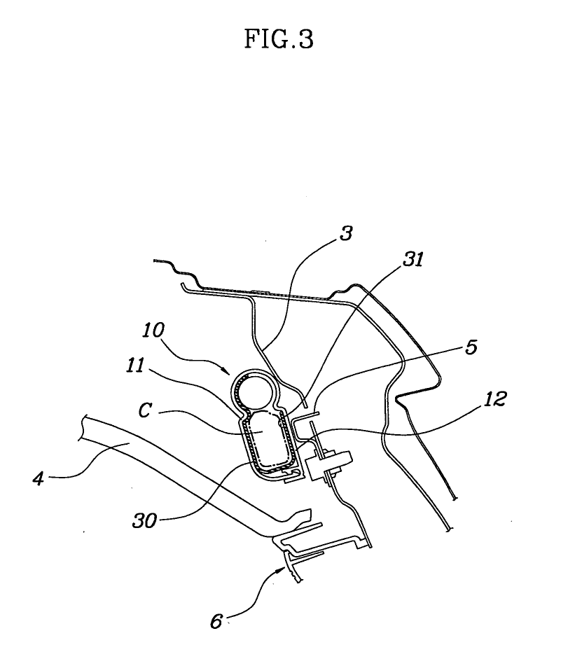

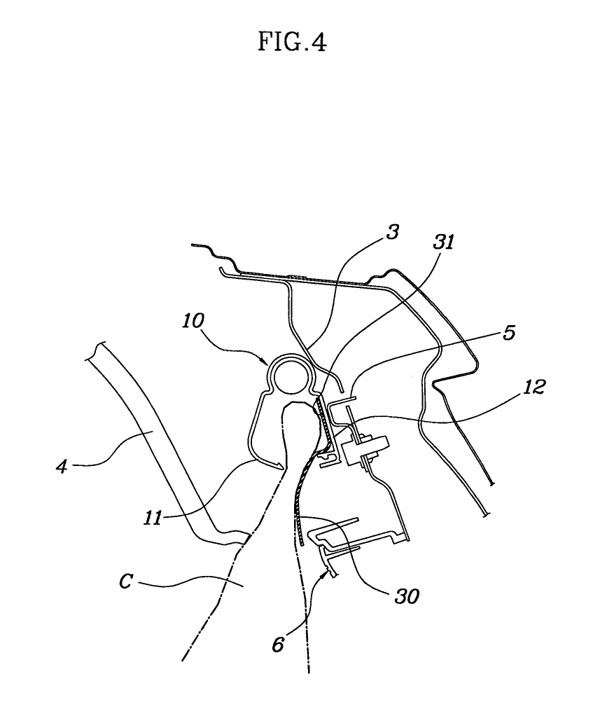

As illustrated in FIGS. 3 and 4, a second embodiment of the present invention is identical in structure to that of the first embodiment; however, a guide 30 is disposed inside covers 11 and 12 for directly covering the cushion (C).

In the second embodiment, one end of guide 30 positioned in cover outer portion 12 forms a third contact portion 31, and the other end of guide 30 encloses the cushion (C) by being extended along cover inner portion 11. As the other end of guide 30 is supported by the inner surface of cover inner portion 11 and the cushion (C), the other end should not be attached to the cover compared to the first embodiment. However, guide 30 may alternatively be attached to the inner surface of cover inner portion 11 or the cushion (C) if necessary.

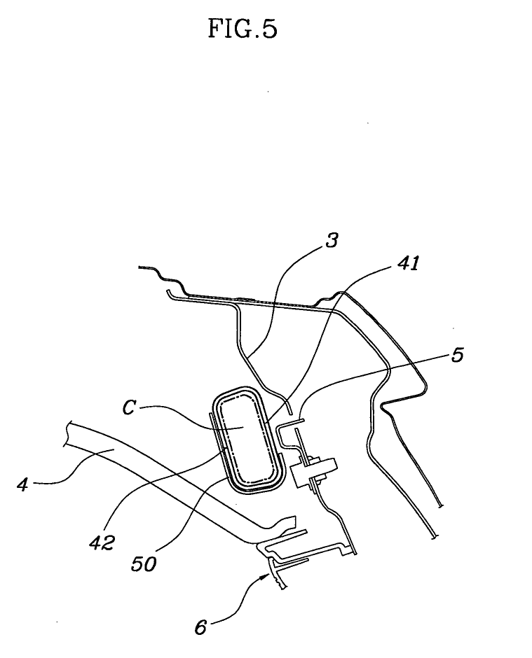

In reference to FIG. 5, a third embodiment of the present invention includes a cover 41 made of a soft material (e.g., a thin textile or vinyl) compared to the hard material used in the aforesaid embodiments. A guide 50 is mounted at the outer periphery of cover 41; however, guide 50 can also be mounted in cover 41. The reference numeral 42 is a detachable portion that is configured to easily be fractured (e.g., pre-manufactured with a partially cut-out section) by the expansion force of the cushion.

Cover 41 made of the soft material may be in an envelope shape to completely close the cushion (C) or in a belt shape to cover the cushion (C) in a predetermined interval along the longitudinal direction of the vehicle body to thereby maintain the folded state of the cushion (C). The guide made of a flexible material such as a textile or leather according to the present invention can be freely attached or fixed to cover 41.

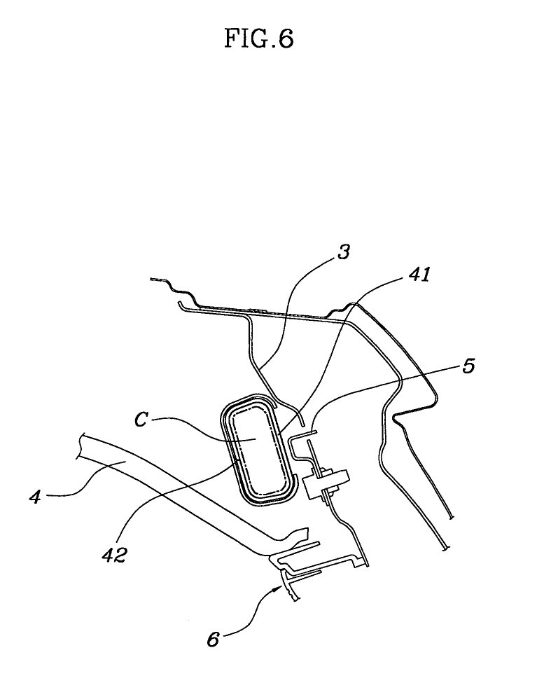

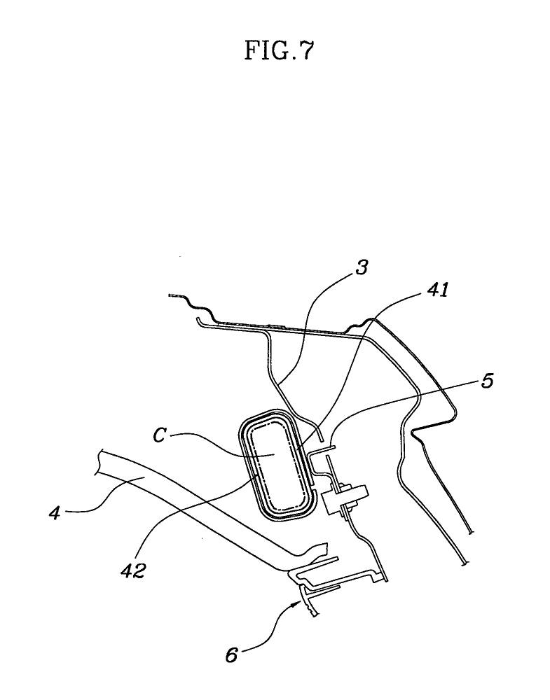

FIGS. 6 and 7 illustrate fourth and fifth embodiments of the present invention and are identical in structure to that of the first embodiment but have different cross-sections of the guide that wraps around the cover.

The cross-section of the guide may be in the shape of “L” for enclosing the outer bottom and one lateral side of the cover (see FIG. 1), a “C” form for enclosing the upper, lower and one lateral side of the cover (see FIG. 6), or an “O” form for surrounding the overall surface of the cover (see FIG. 7). However, in case the guide has the O-shaped cross-section, a cutting portion should be formed thereat.

Even if the guide encloses the cushion in the cover, the shape of the guide may be in “L”, “C”, or “O” configuration, identical to the above cross-sections of the guide.

The guide thus described is designed to prevent the collision of the cushion with the upper end of the center pillar trim when the cushion expands, therefore, the width of the guide should be sufficient merely to cover the center pillar trim.

As apparent from the foregoing, there is an advantage in that the other end of the guide shrouds the upper end of the center pillar trim corresponding to the expansion of the curtain airbag, thereby preventing the deformation of the center pillar trim or collision of the cushion with the upper end of the center pillar trim.

Furthermore, as the guide is made of a flexible material, the attachment of the guide is easily achieved at any desired positions regardless of the construction change of the vehicle body or curtain airbag.

What is claimed is:

1. A mounting structure of a curtain airbag installable between a head lining and roof side inner panel in a longitudinal direction of a vehicle body wherein a cushion is folded and stored in covers having detachable portions for being separated from each other during an expansion of said cushion to thereby facilitate the deployment of said cushion, the structure comprising:
a guide made of a flexible material for enclosing an outer periphery of said covers, and one end of said guide is fixed to an outer surface of said cover whereby said guide shrouds an upper end of a center pillar trim during the deployment of said cushion.

2. The structure as defined in claim 1, wherein said guide is fixed at one end thereof to a bottom of a cover outer portion facing the exterior in relation to said detachable portion of said cover, and the other end of said guide is detachably and loosely attached to said cover.

3. The structure as defined in claim 2, wherein said guide is fixed at the one end thereof to said cover by means of sewing, adhesives, or fixing members.

4. The structure as defined in claim 2, wherein a cross-section of said guide is in the shape of “L” for enclosing said cover.

5. The structure as defined in claim 2, wherein a cross-section of said guide is in the shape of “C” for enclosing said cover.

6. The structure as defined in claim 2, wherein a cross-section of said guide is in the shape of “O” with a cutting portion for enclosing said cover.

7. A mounting structure of a curtain airbag installable between a head lining and roof side inner panel in a longitudinal direction of a vehicle body wherein a cushion is folded and stored in covers having detachable portions for facilitating the expansion of said cushion, the structure comprising:
a guide made of a flexible material for enclosing said cushion folded in said covers, and one end of said guide is fixed in said cover whereby said guide shrouds an upper end of a center pillar trim during the deployment with said cushion.

8. The structure as defined in claim 7, wherein said guide is fixed at one end thereof to an inner surface of a cover outer portion facing the exterior in relation to said detachable portion of said cover.

9. The structure as defined in claim 7, wherein said guide is fixed at the one end thereof to said cover by means of sewing, adhesives, or fixing members.

10. The structure as defined in claim 7, wherein a cross-section of said guide is in the shape of “L” for enclosing said cushion.

11. The structure as defined in claim 7, wherein a cross-section of said guide is in the shape of “C” for enclosing said cushion.

12. The structure as defined in claim 7, wherein a cross-section of said guide is in the shape of “O” with a cutting portion for enclosing said cushion.
